(19) United States
(12) Patent Application Publication
(10) Pub. No.: US 2007/0189163 A1
(43) Pub. Date: Aug. 16, 2007

(54) COMPUTER SYSTEM AND CONTROL, METHOD FOR THE COMPUTER SYSTEM

(75) Inventor: Hiromi Ozawa, Yamanashi (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/673,950

(22) Filed: Feb. 12, 2007

(30) Foreign Application Priority Data
Feb. 14, 2006 (JP) 2006/36691

(51) Int. Cl. H04L 12/26

(52) U.S. Cl. 370/230

(57) ABSTRACT

A system, comprising, a first apparatus; and a second apparatus which transmits first data of a first amount to said first apparatus, wherein said first apparatus comprises, a memory element which stores said first data, a first controller which transmits a first signal for adjusting said first amount when said first amount need to be adjusted or a second signal corresponding to a second amount of a second data extracted from said memory element when said first amount does not need to be adjusted, to said second apparatus through a signal line, wherein said second apparatus comprises, a second controller which updates a third signal corresponding to a third amount of third data that said first apparatus permits of receiving, based on said first signal, a third controller which determines to transmit said first data when said third amount is equal to or larger than said first amount.

### BACKGROUND OF THE INVENTION

The present invention relates to a technique of data transmission from a transmitting apparatus to a receiving apparatus, and more particularly, to a technique of data transmission control based on a permissible amount of transmissible data.

When data is transmitted from the transmitting apparatus to the receiving apparatus, it is necessary to perform flow control for controlling data transmission from the transmitting apparatus so that a buffer (receiving data buffer) provided for the receiving apparatus does not become full. In the past, as shown in Laid-open No. 61-63140, a flow control was performed in which a special character indicating whether data transmission is allowed or not is transmitted from the receiving apparatus to the transmitting apparatus to control data transmission. However, the following problems reside in the flow control performed by transmitting the special character. First, the flow control cannot be performed when a data transmission speed is high. Second, reliable control cannot be performed. Third, it is difficult to handle transaction processing.

Accordingly, as one of flow control systems used when data is transmitted from the transmitting apparatus to the receiving apparatus, there has been used credit-based flow control in which the receiving apparatus transmits a credit to the transmitting apparatus, and the transmitting apparatus transmits data whose amount corresponds to the received credit. In the credit-based flow control, the receiving apparatus generates a credit based on the amount of data processed in the receiving data buffer or an amount of available space of the receiving data buffer, and transmits the credit to the transmitting apparatus as a reception credit. At this time, the transmitting apparatus should receive data whose amount corresponds to the reception credit. The transmitting apparatus receives the reception credit from the receiving apparatus and adds the reception credit to a transmittable credit stored therein. When the transmittable credit is equal to or more than a credit corresponding to the amount of data to be transmitted (transmission credit), the transmitting apparatus transmits data to the receiving apparatus. The credit expresses an amount of data. In the technical field of the flow control for data transmission, the amount of data is not directly expressed in units of bytes or kilobytes, and the amount of data or the amount of data transmitted is often expressed in units of credits on the assumption that a predetermined amount of data is defined as one credit in advance. An example of the credit-based flow control is disclosed in Laid-open No. 2004-235728.

FIG. 7 shows an example of a configuration of a conventional flow control system in which data transmission is controlled by the credit-based flow control. The conventional flow control system performs flow control when data is transmitted from a transmitting apparatus to a receiving apparatus. The conventional flow control system is configured by a transmitting apparatus 101 for transmitting data and a receiving apparatus 102 for receiving data transmitted from the transmitting apparatus 101. The transmitting apparatus 101 shown in FIG. 7 serves as an interface to the receiving apparatus. Similarly, the receiving apparatus 102 shown in FIG. 7 serves as an interface to the transmitting apparatus. Between the transmitting apparatus 101 and the receiving apparatus 102, there are a data line through which data is transmitted and received as a data signal 109 and a signal line through which a credit is notified as a credit notification signal 110 from the receiving apparatus 102 to the transmitting apparatus 101.

The receiving apparatus 102 includes a first-in, first-out (FIFO) receiving data buffer 107 for temporarily storing data received from the transmitting apparatus 101, and a credit notification control circuit 108 for calculating a credit (reception credit) to be notified to the transmitting apparatus 101. Data stored in the receiving data buffer 107 can be taken out from another circuit (not shown) included in the receiving apparatus. In the receiving apparatus 102, when the received data which is stored in the receiving data buffer 107 is transmitted to another circuit of the receiving apparatus in order to process the received data, a reception data credit signal 111 which is used to notify of a credit corresponding to the amount of taken out received data is transmitted from the receiving data buffer 107 to the credit notification control circuit 108. The credit notification control circuit 108 calculates a reception credit to be notified to the transmitting apparatus 101, based on the reception data credit signal 111, and notifies the transmitting apparatus 101 of the calculated reception credit.

The transmitting apparatus 101 includes a transmission data buffer 103 for storing transmission data, a transmission credit calculating circuit 104 for calculating and holding a credit of data stored in the transmission data buffer 103 as a transmission credit, a transmittable-credit calculating and holding circuit 105 for calculating and holding a transmittable credit in the transmitting apparatus 101, and a flow control circuit 106 for performing flow control. Transmission data is sent from a circuit (not shown) provided in the transmitting apparatus and serving as a data transmission source to the transmission data buffer 103. Transmission data is temporarily stored in the transmission data buffer 103. The transmission data buffer 103 transmits the stored transmission data to the receiving apparatus 102 under the control of the flow control circuit 106.

The transmission credit calculating circuit 104 notifies, when data is transmitted from the transmission data buffer 103 to the receiving apparatus 102, the transmittable-credit calculating and holding circuit 105 of a credit corresponding to the amount of transmission data transmitted from the transmission data buffer 103. The transmittable-credit calculating and holding circuit 105 subtracts the credit notified by the transmission credit calculating circuit 104 from the transmittable credit stored in the transmittable-credit calculating and holding circuit 105 when the transmission data buffer 103 transmits data to the receiving apparatus 102. And, when the transmittable-credit calculating and holding circuit 105 receives the reception credit from the receiving apparatus 102, the transmittable-credit calculating and holding circuit 105 adds the reception credit to the transmittable credit in order to update the transmittable credit. Note that, at the time of initialization of the flow control system, a credit corresponding to the capacity of the receiving data buffer 107 obtained when the receiving data buffer 107 is vacant is generally set up as a transmittable credit.

The flow control circuit 106 compares the transmittable credit stored in the transmittable-credit calculating with holding circuit 105 with the transmission credit stored in the transmission credit calculating circuit 104, and performs the flow control according to a result of the comparison. Specifically, when the transmittable credit is equal to or larger than the transmission credit, the flow control circuit 106 orders the transmission data buffer 103 to transmit data to be transmitted to the receiving apparatus 102. On the other hand, when the transmittable credit is smaller than the transmission credit, the flow control circuit 106 temporarily stops transmitting data until the transmittable credit becomes equal to or larger than the transmission credit.

Next, an operation of the conventional flow control system shown in FIG. 7 is described with reference to a flowchart shown in FIGS. 8A to 8C. FIG. 8A shows a data transmission process performed in the transmitting apparatus 101 and a transmittable credit update process performed in the transmittable-credit calculating and holding circuit 105. FIG. 8B shows data receiving process performed in the receiving apparatus 102 and a credit update process performed in the credit notification control circuit 118. FIG. 8C shows a transmittable credit update process performed by receiving a reception credit in the transmitting apparatus 101. As described above, before a data transmission is started, the transmittable credit stored in the transmittable-credit calculating and holding circuit 105 is equal to the credit of the receiving data buffer 107. In other words, the amount of available space of the receiving data buffer 107 is set up as the transmittable credit. The transmittable credit is referred to as a credit “B”, for example.

First, an operation of the transmitting apparatus 101 when the transmitting apparatus 101 receives data whose amount is expressed by the credit “A” from a transmission source circuit of the transmitting apparatus, or another system is described.

Referring to FIG. 8A, transmission data having the credit “A” is stored in the transmission data buffer 103(step 201). The transmission credit stored in the transmission credit calculating circuit 104 is updated to “A” (step 202). The transmittable credit “B” stored in the transmittable-credit calculating and holding circuit 105 is compared with the transmission credit “A” (step 203). When “A” is equal to or smaller than “B” as a result of the comparison, the transmittable credit is equal to or larger than the transmission credit. In other words, the amount of available space of the receiving data buffer 107 is equal to or larger than the amount of data stored in the transmission data buffer 103. Accordingly, the flow control circuit 106 transmits the data having the credit “A” from the transmission data buffer 103 to the receiving apparatus 102 (Step 204). After data is transmitted, the transmission data buffer 103 becomes vacant. By transmission data which has the credit “A”, the transmittable credit stored in the transmittable-credit calculating and holding circuit 105 is updated to ” (B minus A)” (step 205). On the other hand, when “A” is larger than “B” in Step 203, the flow control circuit 106 does not transmit data and keeps waiting until “A” becomes equal to or smaller than the transmittable credit. Note that, in the case of the credit-based flow control, it is assumed that the transmission data having the credit “A” is transmitted to the receiving apparatus 102 as a group of data. Thus, an operation that the transmission data is split into pieces of partial data according to a space of the receiving data buffer 107 and the partial data is transmitted to the receiving apparatus 102 is not performed.

After the transmitting apparatus 101 transmits the transmission data having the credit “A” as described above, the receiving apparatus 102 receives the transmission data having the credit “A” (step 206). The received data is stored in the receiving data buffer 107. When a circuit of the receiving apparatus 102 takes out the transmission data having the credit “A” from the receiving data buffer 107, the credit stored in the credit notification control circuit 108 is updated to “A” (step 207). The credit notification control circuit 108 notifies the transmitting apparatus 101 of a reception credit “A” by using a credit notification signal 110 (step 208).

After the receiving apparatus 102 transmits the credit notification signal 110, the transmittable-credit calculating and holding circuit 105 of the transmitting apparatus 101 receives the reception credit “A” from the receiving apparatus 102 (step 209, FIG. 8C). Then, the transmittable-credit calculating and holding circuit 105 adds “A” to the transmittable credit (the transmittable credit is “(B minus A) ” at the time just before the addition) stored therein to update the transmittable credit to “B” (which is equal to the sum of “(B minus A)” and “A”). The flowchart returns to Step 201 and repeats the above-described processing to transmit next transmission data.

In the flow control described above, the transmittable credit which represents an available space of the receiving data buffer 107is compared with the credit of transmission data, and then the transmission data is transmitted to the receiving apparatus 102. Thus, a buffer overflow of the receiving data buffer 107 is prevented. Note that, in this flow control system, receiving data is taken out from the receiving data buffer 107. Except when a process for the reception credit corresponding to the receiving data taken out from the receiving data buffer 107 is not finished in the transmittable-credit calculating and holding circuit 105, the transmittable credit generally matches a credit corresponding to the amount of available space of the receiving data buffer 107.

There are cases in which the receiving apparatus 102 needs to stop data transmission while the above-mentioned flow control is being performed, regardless of the available space of the receiving data buffer 107. Those cases include a case of changing the system configuration of the receiving apparatus 102 (for example, a crossbar route is changed to change the data routing destination). However, in the above-mentioned conventional credit-based flow control system, since whether to perform data transmission is judged in the transmitting apparatus 101, it is impossible for the receiving apparatus 102 to instruct the transmitting apparatus 101 to stop data transmission from the transmitting apparatus 101 when the receiving data buffer 107 has available space. Further, there is a case in which, to evaluate a test data that is transmitted from transmitting apparatus 101 and has a quite small credit, it is desired to receive only data having a quite smaller credit than that corresponding to the amount of available space (i.e., transmittable credit) of the receiving data buffer 107. However, since the receiving apparatus 102 cannot issue an instruction, data having larger amount than the test data is transmitted instead of the test data.

To stop data transmission from the transmitting apparatus without issuing a stop instruction from the receiving apparatus, there is a method in which when the receiving apparatus receives data, the receiving apparatus does not transmit a reception credit to the transmitting apparatus when the receiving apparatus receives data irrespective of whether data is taken out from the receiving data buffer. According to this method, the transmittable credit of the transmitting apparatus keeps decreasing every time the transmission data is transmitted to the receiving apparatus and finally becomes zero or a value close to zero. As a result, every piece of transmission data has a credit larger than the transmittable credit, so the transmitting apparatus does not transmit the transmission data to the receiving apparatus. A method of this type is disclosed in Laid-open No. 2004-72547, for example. However, with this method, it is impossible to properly grasp an elapsed time from when transmission of a reception credit from the receiving apparatus is stopped to when data transmission from the transmitting apparatus is stopped. Further, when transaction data is transmitted, a reply that includes a reception credit is returned from the receiving apparatus to the transmitting apparatus after the transmission data is transmitted from the transmitting apparatus to the receiving apparatus. If the reception credit is not transmitted to the transmitting apparatus, the reply is not returned. Accordingly, in a case of transaction processing having a time-out concept, the transmitting apparatus may detect a reply time-out and regard the reply time-out as a system failure. For example, the credit-based flow control is performed on PCI-Express used for an internal bus in a computer system or a bus which connects a computer system and an extension board. However, since a time-out concept resides therein, the receiving apparatus has to return a reply to a transaction issued by the transmitting apparatus within a fixed period of time. Thus, in the case of PCI-Express, the method of preventing data transmission from the transmitting apparatus without transmitting a reception credit to the transmitting apparatus cannot be used.

In Laid-open No. 09-200290, there is disclosed credit-based flow control in which data transmission from the transmitting apparatus is stopped by not transmitting information used to update a credit stored in the transmitting apparatus from the receiving apparatus.

Note that if a new signal line for transmitting a transmission stop instruction from the receiving apparatus to the transmitting apparatus is provided, the receiving apparatus can instruct the transmitting apparatus to stop data transmission, thereby solving the above-mentioned problem. However, providing the new signal line for transmitting a transmission stop instruction can cause a large increase in cost, and further, it maybe difficult to provide the new signal line. In addition, each of the transmitting apparatus and the receiving apparatus needs to be configured considering the new signal line. So, to stop data transmission by transmitting the transmission stop instruction through the new signal line is hardly applied to an existent flow control system or a system which uses an apparatus of different vendors.

### SUMMARY OF THE INVENTION

As described above, in the conventional credit-based flow control system, it is impossible to stop or suppress data transmission by an instruction from the receiving apparatus. This problem is caused by a configuration in which a credit corresponding to the amount of available space or an increase in the amount of available space of the receiving data buffer is constantly notified from the receiving apparatus to the transmitting apparatus. However, even if transmission of a credit from the receiving apparatus to the transmitting apparatus is prevented, the receiving apparatus cannot predict the time when data transmission from the transmitting apparatus ends, and reply time-out occurs in the transaction which requires return of a reply. When the new signal line is provided to instruct to stop data transmission from the receiving apparatus to the transmitting apparatus, the cost increases, and modification of the hardware is required.

A system, comprising: a first apparatus; and a second apparatus which transmits first data having a first amount to said first apparatus, wherein said first apparatus comprises: a memory element which stored said first data; a first controller which transmits a first signal for adjusting said first amount when said first amount need to be adjusted or a second signal indicating a second amount of a second data extracted from said memory element when said first amount does not need to be adjusted, to said second apparatus through a signal line; and wherein said second apparatus comprises: a second controller which updates a third signal indicating a third amount of third data that said first apparatus permits of receiving, based on said first signal; and a third controller which determines to transmit said first data when said third amount is equal to or larger than said first amount.

An apparatus which receives first data having a first amount from another apparatus, comprising: a memory element which stored said first data; and a controller which transmits a first signal for adjusting said first amount when said amount need to be adjusted or a second signal indicating a second amount of a second data extracted from said memory element when said first amount does not need to be adjusted, to said another apparatus through a signal line.

An apparatus which transmits first data having a first amount to another apparatus having a memory element for storing said first data, comprising: a first controller which receives a first signal for adjusting said first amount when said another apparatus need to adjust said first amount or a second signal indicating a second amount of second data extracted from said memory element when said first amount does not need to be adjusted, from said another apparatus through a signal line; wherein said first controller updates a third signal indicating a third amount of third data that said another apparatus permits of receiving, based on said first signal; and a second controller which determines to transmit said first data when said third amount is equal to or larger than said first amount.

A system, comprising: a first apparatus; and

a second apparatus which transmits first data to said first apparatus, wherein said first apparatus comprises: a memory element which stores said first data; a first storage element which stores a first signal indicating a first amount of second data extracted from said memory element; a second storage element which stores a second signal indicating a second amount that is smaller than that of said first signal; a select circuit which transmits said first signal to said second apparatus while said first apparatus accepts a data transmission from said second apparatus, and transmits said second signal to said second apparatus when said first apparatus suspends said data transmission from said second apparatus; and

said second apparatus comprises: a third storage element which stores said first signal or said second signal as a third signal; a fourth storage element which stores a fourth signal indicating a third amount of third data that is ready to be transmitted to said first apparatus; and a controller which permits said data transmission when said third amount indicated by said fourth signal is equal to or smaller than that of said third signal.

A method for controlling a system having a first apparatus and a second apparatus transmitting first data having a first amount to said first apparatus, comprising: storing said first data in a memory element; transmitting a first signal for adjusting said first amount when said first amount need to be adjusted or a second signal indicating a second amount of a second data extracted from said memory element when said first amount does not need to be adjusted, to said second apparatus through a signal line; and updating a third signal indicating a third amount of said third data that said first apparatus permits of receiving, based on said first signal; and

determining to transmit said first data when said third amount is equal to or larger than said first amount.

A method of controlling a apparatus, comprising: receiving first data having a first amount from another apparatus; storing said first data in a memory element; and transmitting a first signal for adjusting said first amount when said amount of said data need to be adjusted or a second signal indicating a second amount of a second data extracted from said memory element when said first amount does not need to be adjusted, to said another apparatus through a signal line.

A method for controlling an apparatus which transmits first data having a first amount to another apparatus having a memory element for storing said first data, comprising: receiving a first signal for adjusting said first amount when said another apparatus need to adjust said first amount or a second signal indicating a second amount of second data extracted from said memory element when said first amount does not need to be adjusted, from said another apparatus through a signal line; updating a third signal indicating a third amount of said third data that said another apparatus permits of receiving, based on said first signal; and determining to transmit said first data when said third amount is equal to or larger than said first amount.

### BRIEF DESCRIPTION OF THE DRAWINGS

Other feature and advantages of the invention will be made apparent by the following detailed description and the accompanying drawings, wherein:

FIG. 1 is a block diagram illustrating a configuration of a flow control system according to a first embodiment of the present invention;

FIG. 2 is a block diagram illustrating a configuration of a credit notification control circuit;

FIG. 3 is a block diagram illustrating a configuration of a transmittable-credit calculating and holding circuit;

FIG. 4A is a flowchart illustrating a process for suspending data transmission between a transmitting apparatus 301 and a receiving apparatus 302 and canceling the suspension of the data transmission;

FIG. 4B is a flowchart illustrating an operation of the transmitting apparatus 301 for updating a transmittable credit;

FIG. 5 is a block diagram illustrating a configuration of a flow control system according to a second embodiment of the present invention;

FIG. 6A is a flowchart illustrating an operation of a transmitting apparatus 701 for updating the credit;

FIG. 6B is a flowchart illustrating an operation of a receiving apparatus 702 for updating the credit;

FIG. 6C is a flowchart illustrating an operation of the transmitting apparatus 701 for updating the credit;

FIG. 6D is a flowchart illustrating a case in which the receiving apparatus 702 issues an instruction to suspend data transmission or to cancel the suspension;

FIG. 7 is a block diagram illustrating a configuration of a conventional flow control system based on a credit;

FIG. 8A is a flowchart illustrating flow control operation based on a transmittable credit;

FIG. 8B is a flowchart illustrating an operation of a receiving section for notifying a credit; and

FIG. 8C is a flowchart illustrating an operation of a transmitting section for updating a transmittable credit.

In the drawings, the same reference numerals represent the same structural elements.

### DETAILED DESCRIPTION OF THE PREFERRED EMBODIMENTS

A first embodiment of the present invention will be described in detail below.

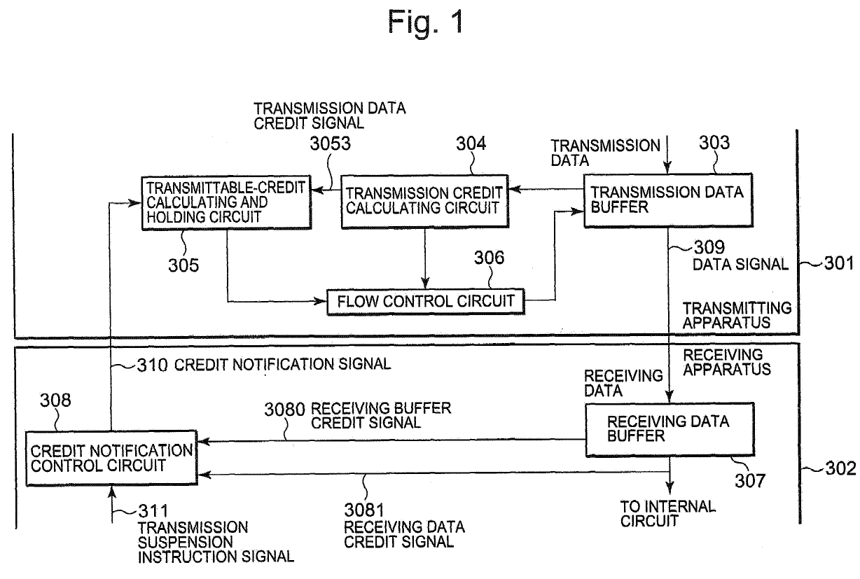

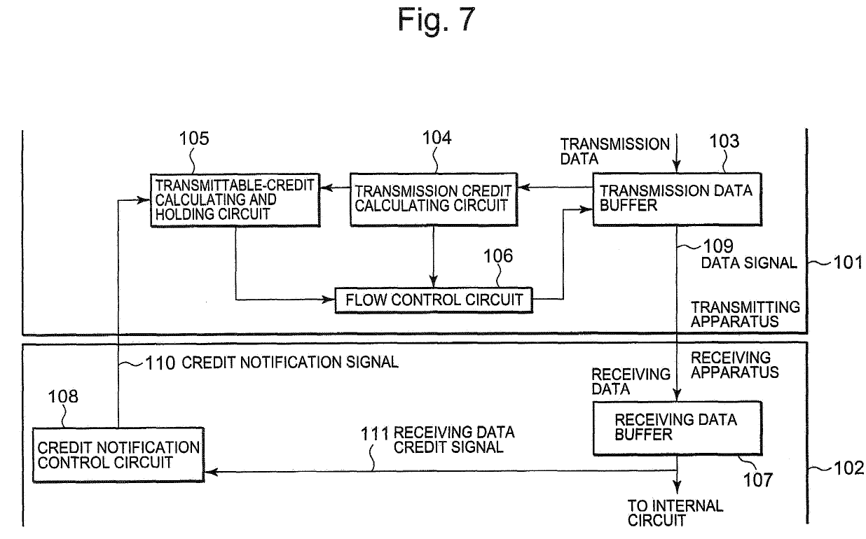

FIG. 1 illustrates a configuration of a flow control system based on a credit. In the flow control system, a flow control is performed by transmitting a reception credit from a receiving apparatus 302 to a transmitting apparatus 301, similarly to the conventional flow control system shown in FIG. 7. The flow control system according to the first embodiment is different from that of FIG. 7 because not only the reception credit capable of increasing a value of transmittable credit stored in the transmitting apparatus 301 but also the reception credit capable of decreasing the value of a transmittable credit can be transmitted from the receiving apparatus 302 to the transmitting apparatus 301. Specifically, a credit having a negative value is transmitted from the receiving apparatus 302 to the transmitting apparatus 301 to update, for example, a value of the transmittable credit to 0, to thereby suspend data transmission from the transmitting apparatus 301 irrespective of a credit of a transmission data stored in a transmission data buffer. In order to cancel the suspension of data transmission, it is only necessary to transmit a credit having an appropriate positive value to the transmitting apparatus 301 from the receiving apparatus 302. Hereinafter, the flow control system shown in FIG. 1 is described in detail.

The flow control system shown in FIG. 1 includes the transmitting apparatus 301 which transmits data, and the receiving apparatus 302 which receives the data transmitted from the transmitting apparatus 301. Between the transmitting apparatus 301 and the receiving apparatus 302, there is provided at least one data line through which data is transmitted and received as a data signal 309, and a plurality of signal lines through which a credit is notified by using a credit notification signal 310 from the receiving apparatus 302 to the transmitting apparatus 301, each serving as an interface.

The receiving apparatus 302 includes a FIFO receiving data buffer 307 for temporarily storing receiving data, and a credit notification control circuit 308 for calculating a credit to be notified to the transmitting apparatus 301. In a case in which the receiving data stored in the receiving data buffer 307 is transferred therefrom to an internal circuit (not shown) of the receiving apparatus 302 so as to be processed, a receiving data credit signal 3081 for notifying the credit of the transferred receiving data is transmitted from the receiving data buffer 307 to the credit notification control circuit 308. Further, the receiving data buffer 307 transmits a receiving buffer credit signal 3080 for notifying the credit (i.e., receiving buffer credit) indicating the space currently available in the receiving data buffer 307 to the credit notification control circuit 308. The credit notification control circuit 308 is configured so as to be supplied with a transmission suspension instruction signal 311 for instructing suspension of data transmission between the transmitting apparatus 301 and the receiving apparatus 302 from the internal circuit (not shown) of the receiving apparatus 302.

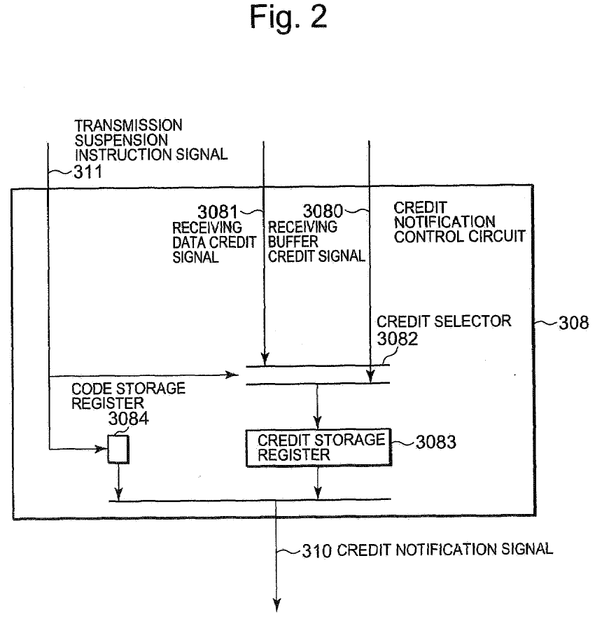

As shown in FIG. 2, the credit notification control circuit 308 includes a credit selector 3082 for selecting one of the receiving buffer credit signal 3080 and the receiving data credit signal 3081 in response to the transmission suspension instruction signal 311, a credit storage register 3083 for storing the credit of one of the credit selected in the credit selector 3082, and a sign storage register 3084 for storing “1” when the sign storage register 3084 receives the transmission suspension instruction signal 311. A credit is represented by a binary signed integer. A negative credit has a most significant bit (MSB) of “1”, and a positive credit has a most significant bit of “0”. Accordingly, the credit notification control circuit 308 generates the credit by setting the content of the sign storage register 3084 for the most significant bit of the credit and setting the content stored in the credit storage register 3083 for lower-order bits. The credit notification control circuit 308 notifies the generated credit as a reception credit to the transmitting apparatus 301.

The transmitting apparatus 301 includes a transmission data buffer 303 for storing transmission data, a transmission credit calculating circuit 304 for calculating the transmission credit, a transmittable-credit calculating and holding circuit 305 for calculating and holding the transmittable credit, and a flow control circuit 306 for performing the flow control. Transmission data temporarily stored in the transmission data buffer 303 is transmitted from an internal circuit of the transmitting apparatus 301 or from another system. The transmission data buffer 303 transmits the transmission data stored therein to the receiving apparatus 302 under the direction of the flow control circuit 306. The transmission credit calculating circuit 304 calculates the transmission credit and, in a case in which the transmission data is transmitted from the transmission data buffer 303, outputs a transmission data credit signal 3053 for notifying the transmittable-credit calculating and holding circuit 305 of the transmission credit. The flow control circuit 306 compares the transmittable credit held in the transmittable-credit calculating and holding circuit 305 with the transmission credit held in the transmission credit computing circuit 304. In a case, in which the transmittable credit is equal to or larger than the transmission credit, the transmission data is transmitted to the receiving apparatus 302. In a case in which the transmittable credit is smaller than the transmission credit, the transmission data is not transmitted until the transmittable credit becomes equal to or larger than the transmission credit.

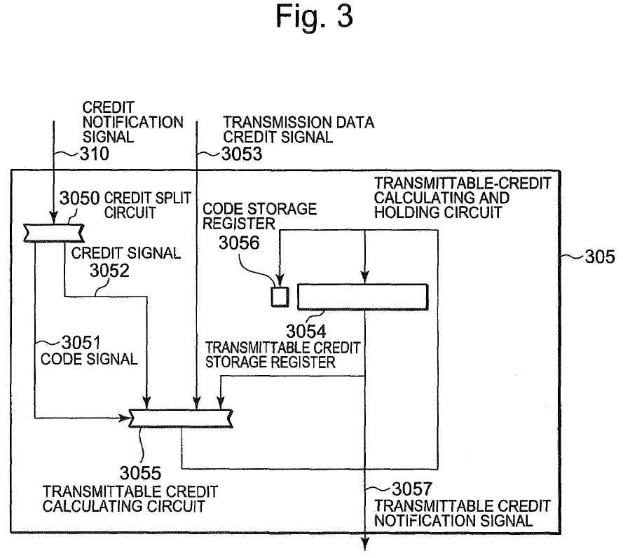

As shown in FIG. 3, the transmittable-credit calculating and holding circuit 305 includes a credit split circuit 3050 for splitting the credit that has received as a notification from the credit notification signal 310 into a code signal 3051 (i.e., MSB of the credit) and a credit signal 3052 (lower-order bits excluding MSB of the credit), a transmittable credit storage register 3054 for storing the transmittable credit, a transmittable credit calculating circuit 3055 for calculating the transmittable credit, and a code storage register 3056 for storing “1” in a case in which it is determined by the calculation in the transmittable credit calculating circuit 3055 that the transmittable credit has a negative value. The transmittable credit held in the transmittable credit storage register 3054 is notified to the flow control circuit 306 by a transmittable credit notification signal 3057.

When the transmission data buffer 303 transmits the transmission data to the receiving apparatus 302, the transmittable credit calculating circuit 3055 subtracts the credit notified by the transmission data credit signal 3053 from the transmittable credit stored in the transmittable credit storage register 3054. Further, upon reception of the credit notification signal 310 having the code signal 3051 of “0” from the receiving apparatus 302, the transmittable credit calculating circuit 3055 calculates the transmittable credit by adding the credit of the credit signal 3052 to the transmittable credit stored in the transmittable credit storage register 3054 and updates the transmittable credit. Further, upon reception of the credit notification signal 310 having the code signal 3051 of “1 from the receiving apparatus 302, the transmittable credit calculating circuit 3055 calculates the transmittable credit by subtracting the credit of the credit signal 3052 from the transmittable credit stored in the transmittable credit storage register 3054 and updates the transmittable credit.

In this embodiment, one of the plurality of signal lines for the credit notification signal 310 is used for transmitting the code signal 3051 of the credit notification signal 310 from the receiving apparatus 302 to the transmitting apparatus 301.

Next, an operation of the flow control system is described. In initializing the flow control system, the transmittable credit is generally assigned a credit corresponding to the space of the receiving data buffer 307 when the receiving data buffer 307 is vacant. In the flow control system, until the transmission data buffer 303 of the transmitting apparatus 301 receives the transmission data, a credit corresponding to the space of the receiving data buffer 307 (i.e., receiving buffer credit) is stored as a transmittable credit in the transmittable credit storage register 3054. In this case, the credit is assumed to be “B”.

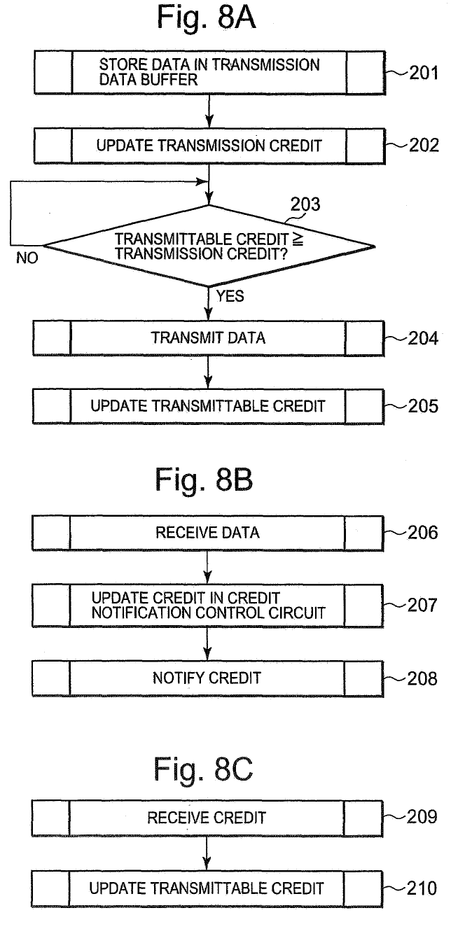

First, a process in a case in which the transmission suspension instruction signal 311 is not inputted to the credit notification control circuit 308 yet is described below. In this case, the content of the code storage register 3084 is “0” and the credit selector 3082 selects the receiving data credit signal 3081. Therefore, the receiving data credit signal 3081 is stored in the credit storage register 3083. As a result, a credit having the most significant bit of “0” and corresponding to an amount of data extracted from the receiving data buffer 307 is transmitted from the receiving apparatus 302 to the transmitting apparatus 301 as the reception credit. The most significant bit of the credit (the reception credit) is “0”, so the credit has a positive value. Also, in this case, the code signal 3051 is “0”. So, a credit corresponding to the credit signal 3052 is added to the transmittable credit. That is, a similar operation as that illustrated in FIGS. 8A to 8C is performed.

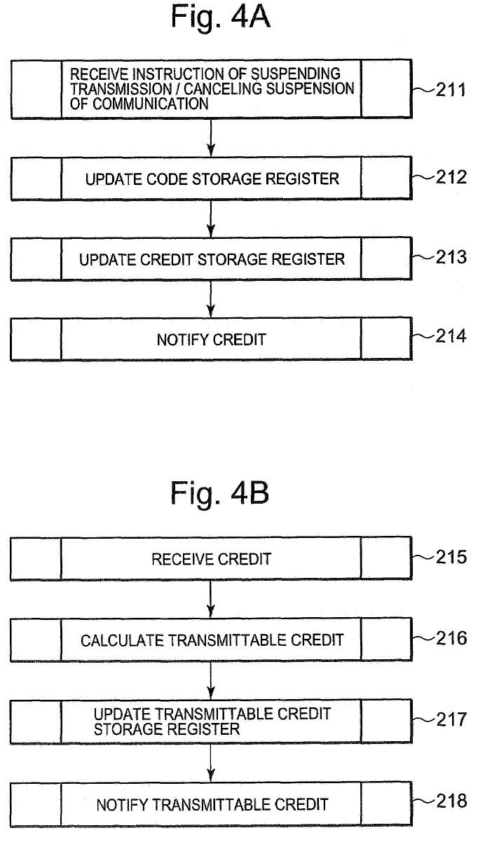

Next, referring to FIGS. 4A and 4B, explained is an operation of the credit notification control circuit 308 in a case in which the receiving apparatus 302 has received an instruction of suspending transmission with the transmitting apparatus or an instruction of canceling the suspension of transmission with the transmitting apparatus based on the transmission suspension instruction signal 311 is described below. FIG. 4A illustrates an operation of the receiving apparatus 302 in a case in which the receiving apparatus 302 has received the instruction of suspending transmission with the transmitting section or the instruction of canceling the suspension of transmission with the transmitting section based on the communication suspension instruction signal 311. FIG. 4B illustrates an operation of the transmittable-credit calculating and holding circuit 305 for updating the transmittable credit upon reception of a credit which is sent from the receiving apparatus 302.

As shown in FIG. 4A, the receiving apparatus 302 receives the instruction of suspending transmission with the transmitting apparatus based on the transmission suspension instruction signal 311 (Step 211). Then, the content of the code storage register 3084 is updated to “1” (Step 212). Since the content of the code storage register 3084 is “1”, the receiving buffer credit signal 3080 is selected by the credit selector 3082 (Step 213). Accordingly, the receiving buffer credit (“B” in this case) is stored in the credit storage register 3083. The content of the code storage register 3084 and the content of the credit storage register 3083 are combined, and a credit “1B” having the most significant bit of “1” and the lower-order bits of “B” is notified to the transmitting apparatus 301 (Step 214). The most significant bit of the credit “1B” is “1” because the value stored in the code storage register 3084 is “1”. Since the most significant bit of the credit “1B” is “1”, the credit “1B” has a negative value even though the credit “1B” has an absolute value of “B”.

As described above, the receiving apparatus 302 transmits the credit notification signal 310 of the credit “1B” as the reception credit. Then, as shown in FIG. 4B, the transmittable-credit calculating and holding circuit 305 receives the credit “1B” (Step 215). The received credit is split into the code signal 3051 and the credit signal 3052 by the credit split circuit 3050 (Step 216). In this case, the code signal 3051 is “1” and the credit signal 3052 is “B”. Upon reception of the credit having the code signal 3051 of “1”, the transmittable credit calculating circuit 3055 subtracts the credit (“B”) notified by the credit signal 3052 from the value stored in the transmittable credit storage register 3054. Therefore, the transmittable credit is “0”, which is obtained by subtracting “B” from “B”. As a result, the transmittable credit calculating circuit 3055 stores the transmittable credit of “0” in the transmittable credit storage register 3054 (Step 217). The transmittable-credit calculating and holding circuit 305 notifies the transmittable credit of “0” to the flow control circuit 306 using the transmittable credit notification signal 3057 (Step 218).

If the transmitting apparatus 301 receives the transmission data having the credit of “D” from the internal circuit or another system in a case in which “0” is set as the transmittable credit, the transmission data having credit of “D” is stored in the transmission data buffer 303 (Step 201), as shown in FIG. 8A. Next, the transmission credit stored in the transmission credit calculating circuit 304 is updated to “D” (Step 202), as shown in FIG. 8A. Then, the flow control circuit 306 compares the transmittable credit (“0” in this case) with the transmission credit (“D” in this case) in Step 203. Herein, because “D” is larger than,“0”, the flow control is performed so as to wait in Step 203 without transmitting the transmission data until “D” becomes equal to or smaller than the transmittable credit.

As described above, when the receiving apparatus 302 receives the instruction of suspending transmission with the transmitting apparatus 301 based on the transmission suspension instruction signal 311, the data transmission between the receiving apparatus 302 and the transmitting apparatus 301 is suspended.

Next, an operation for restarting the data transmission from the state where the data transmission between the receiving apparatus 302 and the transmitting apparatus 301 is suspended is described below.

As shown in FIG. 4A, the receiving apparatus 302 receives the transmission suspension instruction signal 311 indicating that the suspension of the data transmission needs to be canceled(Step 211). As a result, the code storage register 3084 in the credit notification control circuit 308 is updated to “0” (Step 212). The receiving buffer credit signal 3080 is selected by the credit selector 3082 (Step 213). Accordingly, the credit (“B” in this case) indicated by the receiving buffer credit signal 3080 is stored in the credit storage register 3083. The credit “0B” is notified to the transmitting apparatus 301 (Step 214). The credit “0B” has the most significant bit of “0” and the lower-order bits of “B”. The most significant bit of “0” corresponds to the stored value of “0” in the code storage register 3084.

The receiving apparatus 302 transmits the credit notification signal 310 of the credit “0B” as the reception credit. Then, as shown in FIG. 4B, the transmittable-credit calculating and holding circuit 305 receives the credit “0B” from the receiving apparatus 302 (Step 215). The received credit “0B” is split into the code signal 3051 (“0” in this case) and the credit signal 3052 (“B” in this case) by the credit split circuit 3050 (Step 216). Since the code signal 3051 is “0”, the transmittable credit calculating circuit 3055 adds the credit notified by the credit signal 3052 to the credit stored in the transmittable credit storage register 3054. Therefore, the transmittable credit becomes “B”, which is obtained by adding “0” to “B”. Subsequently, the transmittable credit calculating circuit 3055 stores the transmittable credit “B” in the transmittable credit storage register 3054 (Step 217). The transmittable credit “B” is notified by the transmittable credit notification signal 3057 to the flow control circuit 306 (Step 218). After the transmittable credit “B” is notified to the flow control circuit 306 as described above, the data transmission from the transmission data buffer 303 to the receiving apparatus 302 is initiated according to the procedure shown in FIG. 8A.

The available space of the receiving data buffer 307 changes because data is extracted therefrom when the data transmission with the transmitting apparatus 301 is suspended. In this case, the credit storage register 3083 stores the receiving buffer credit used when the suspension of transmission was indicated based on the transmission suspension instruction signal 311 (Step 213). Further, in order to deal with the change of the available space of the receiving data buffer 307 due to the extraction of data while suspending the data transmission, the receiving data credit 3081 corresponding to the extracted data is transmitted to the transmitting apparatus 301 as a reception credit.

The operations when the instruction of suspending transmission with the transmitting apparatus 301 and the instruction of canceling the suspension of transmission with the transmitting apparatus 301 are received using the transmission suspension instruction signal 311 have been explained as above. In each case, both the transmittable credit and the receiving buffer credit are “B”. As long as the transmittable credit is set so as to correspond to the space of the receiving data buffer 307 when the system is initialized, the value of the transmittable credit is same as that of the receiving buffer credit, except for a case in which the cancellation of transmission is instructed or the like. However, in some cases, the transmittable credit and the receiving buffer credit included in the receiving buffer credit signal 3080 may be different from each other.

For example, the receiving data credit included in the receiving data credit signal 3081 should be transmitted to the transmitting apparatus 301 when data is extracted from the receiving data buffer 307, but when the receiving data credit has not been transmitted completely the transmittable credit (“C” in this case) stored in the code storage register 3054 is smaller than the receiving buffer credit “B” of the receiving data buffer 307. The transmittable credit “C” is smaller than the receiving buffer credit “B”. In this case, the transmitting apparatus 301 receives the credit “1B” from the receiving apparatus 302 (Step 215), and the transmittable credit calculating circuit 3055 performs calculation to obtain the transmittable credit “(C-B)” (Step 216). It means that the transmittable credit has a negative value. As a result, “1” is stored in the code storage register 3056 and the transmittable credit “(C-B)” is stored in the transmittable credit storage register 3054 (Step 217). The transmittable-credit calculating and holding circuit 305notifies the transmittable credit “(C-B)” to the flow control circuit 306 by using the transmittable credit notification signal 3057 (Step 218). Also in this case, the transmission credit of transmission data is always larger than the transmittable credit. Therefore, the transmission of the transmission data is prevented.

Herein, a method for canceling the suspension of the data transmission in this case is explained. In a case in which the transmittable credit “(C-B)” having a negative value is stored in the transmittable credit storage register 3054 and “1” is stored in the code storage register 3056, the transmitting apparatus 301 receives the credit “0B” from the receiving apparatus 302 (Step 215). The transmittable credit calculating circuit 3055 performs calculation, in which “B” is added to “(C-B)”, to obtain the transmittable, credit “C” (Step 216). It means that the transmittable credit has a positive value. Accordingly, “0” is stored in the code storage register 3056 and the transmittable credit “C” is stored in the transmittable credit storage register 3054 (Step 217). The transmittable-credit calculating and holding circuit 305 notifies the transmittable credit “C”, which is larger than 0, to the flow control circuit 306 by using the transmittable credit notification signal 3057 (Step 218). As a result, the transmitting apparatus 301 establishes a state where the transmitting apparatus 301 can transmit data to the receiving apparatus 302. However, the transmission of the receiving data credit included in the receiving data buffer credit signal 3081 in order to deal with the extraction of data from the receiving data buffer 307 has not been finished at this time. Therefore, the transmittable credit “C” is smaller than the receiving buffer credit “B” corresponding the space of the receiving data buffer 307. After that, by transmitting the receiving data credit included in the receiving data credit signal 3081 as the reception credit, the process for the receiving data credit is performed in the transmitting apparatus 301 according to the above-mentioned procedure shown in FIGS. 8A to 8C. As a result, the transmittable credit corresponds with the credit corresponding to the space of the receiving data buffer 307. In consideration of reply time-out in transaction process, it is preferable that the receiving data credit included in the receiving data credit signal 3081 be initially transmitted to the transmitting apparatus 301 previous to the suspension of the data transmission between the transmitting apparatus 301 and the receiving apparatus 302.

Also in a case in which the transmission data is transmitted from the transmission data buffer 303 to the receiving apparatus 302 but the transmission data has not been received by the receiving data buffer 307, the transmittable credit may be smaller than the receiving buffer credit included in the receiving buffer credit signal 3080. In this case, it is possible to suspend the data transmission from the transmitting apparatus 301 or to cancel the suspension by performing the similar process described above.

In this embodiment, it is possible not only to suspend the data transmission from the transmitting apparatus 301 but also to limit the amount of the transmission data transmitted from the transmitting apparatus 301 based on the instruction from the receiving apparatus 302. To limit the amount of the transmission data, the credit corresponding to the amount of data which the receiving apparatus 302 wants to receive is set to “E”, and the credit having a negative value and an absolute value of “(B-E)” is transmitted to the transmitting apparatus 301 in order to give an instruction of limiting the data transmission. In order to cancel the limitation, the credit having a positive value and an absolute value of “(B-E)” is transmitted to the transmitting apparatus 301.

In the above description, the credit transmitted from the receiving apparatus 302 to the transmitting apparatus 301 is represented by a binary signed integer. Alternatively, it is also possible to use a binary complement integer, which is generally used for operation performed by a computer. Whether the binary signed integer or the binary complement integer should be used may be determined based on the addition logic especially used for adding the reception credit to the transmittable credit in the transmittable-credit calculating and holding circuit 305. In a case in which the binary complement integer is used, a complement calculation circuit for obtaining a complement of the receiving data credit signal 3081 is provided in the credit notification control circuit 308 whereby the complement of the receiving data credit signal 3081 may be inputted in the credit storage register 3083.

Assume a case in which it is already possible for the transmitting apparatus 301, upon receiving of a credit having a negative value, to reduce the value of the transmittable credit based on the value of the credit. In this case, when the flow control according to this embodiment is applied to a conventional system, it is preferable that only the receiving apparatus 302 may have the configuration described above. Considering the implementation of a general integer arithmetic operation, a transmitting apparatus 301 capable of reducing the value of the transmittable credit upon receiving the credit having a negative value can be regarded as wide spread. Therefore, it may be necessary to provide only the receiving apparatus 302 with the above-mentioned configuration in order to establish the flow control system according to this embodiment.

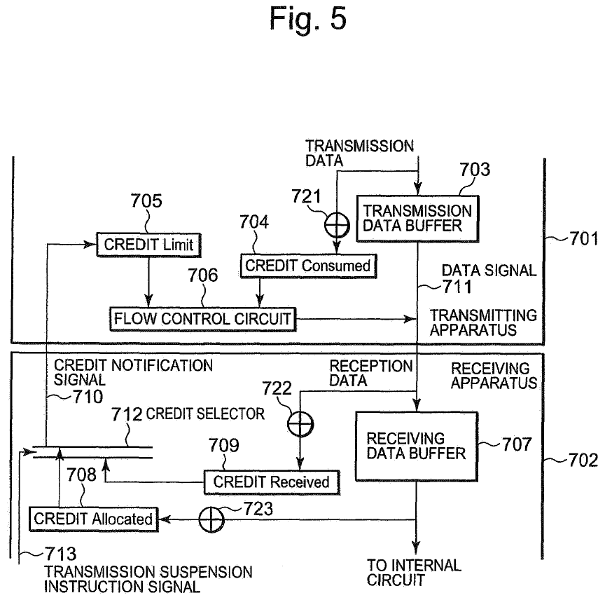

Subsequently, a flow control system according to a second embodiment of the present invention will be explained. In the second embodiment, the flow control system according to the present invention is applied to an interface of a PCI-Express protocol. FIG. 5 shows the flow control system according to the second embodiment.

The flow control system shown in FIG. 5 includes the transmitting apparatus 701 for transmitting a transmission data and a receiving apparatus 702 for receiving the transmission data transmitted from the transmitting apparatus 701. Between the transmitting apparatus 701 and the receiving apparatus 702, there are a plurality of data lines through which data itself is transmitted and received as a data signal 711, and a plurality of signal lines through which credit notification signal 710 is transmitted from the receiving apparatus 702 to the transmitting apparatus 701, each serving as an interface.

The receiving apparatus 702 includes a receiving data buffer 707, an accumulator 722, a CREDIT Received 709, an accumulator 723, a CREDIT Allocated 708, a credit selector 712. The receiving data buffer 707 of the FIFO type temporarily stores the data transmitted from the transmitting apparatus 701. The accumulator 722 accumulates the credit of the data transmitted from the transmitting apparatus 701 every time the accumulator 722 receives the data transmitted from the transmitting apparatus 701. The CREDIT Received 709 is a register for storing the accumulation result obtained by the accumulator 722. The accumulator 723 accumulates the credit of data extracted from the receiving data buffer 707. The accumulator 723 accumulates the credit every time the data is extracted from the receiving data buffer 707 and transmitted from the receiving data buffer 707 to the internal circuit of the receiving apparatus 702. The CREDIT Allocated 708 is a register for storing the accumulation result obtained by the accumulator 723. The credit selector 712 selects one of the credit stored in the CREDIT Allocated 708 and the credit stored in the CREDIT Received 709. A transmission suspension instruction signal 713 for instructing suspension of data transmission between the transmitting apparatus 701 and the receiving apparatus 702 is supplied from the internal circuit of the receiving apparatus 702 to the credit selector 712. The credit selector 712 selects one of the credit from the credit stored in the CREDIT Allocated 708 and the credit stored in the CREDIT Received 709 based on the transmission suspension instruction signal 713. And, the credit selector 712 transmits the selected credit by using a credit notification signal 710 indicating the reception credit. The credit stored in the CREDIT Allocated 708 is a credit which is to be notified to the transmitting apparatus 701 based on PCI-Express standard when the data transmission between the transmitting apparatus 701 and the receiving apparatus 702 is not suspended.

The transmitting apparatus 701 includes a transmission data buffer 703, an accumulator 721, a CREDIT Consumed 704, a CREDIT Limit 705, a flow control circuit 706. The transmission data buffer 703 temporarily stores the transmission data transmitted from the internal circuit of the transmitting apparatus 701, an external system. The accumulator 721 accumulates the credit of the transmission data every time the transmission data is stored in the transmission data buffer 703. The CREDIT Consumed 704 is a register for storing the accumulation result obtained by the accumulator 721. The CREDIT Limit 705 is a register for storing the reception credit received from the receiving apparatus 702. The flow control circuit 706 performs the flow control. The credit is notified from the receiving apparatus 702 point by point. When the credit notified from the receiving apparatus 702 changes, the credit stored in the CREDIT Limit 705 also changes immediately.

In PCI-Express protocol, each credit is accumulated by each of the accumulators 721, 722, and 723 using a circulation-type operation in which an overflow is ignored. The flow control circuit 706 compares the credit stored in the CREDIT Limit 705 with the credit stored in the CREDIT Consumed 704. In a case in which the credit stored in the CREDIT Limit 705 is equal to or larger than the credit stored in the CREDIT Consumed 704, the transmission data stored in the transmission data buffer 703 is transmitted. In a case in which the credit stored in the CREDIT Limit 705 is smaller than the credit stored in the CREDIT Consumed 704, the data transmission is temporarily suspended. The suspension of the data transmission is continued until the credit stored in the CREDIT Limit 705 becomes equal to or larger than the credit stored in the CREDIT Consumed 704.

The flow control system of this embodiment, in which the credit is calculated by accumulating, is greatly different from the flow control system shown in FIG. 1, in which the credit is added or subtracted based on the amount of data transmitted or received, in terms of the calculation process of the credit. However, each credit of this embodiment corresponds to each credit in the flow control system shown in FIG. 1. The credit stored in the CREDIT Consumed 704 corresponds to the transmission credit. The credit stored in the CREDIT Limit 705 corresponds to the transmittable credit. The credit stored in the CREDIT Allocated 708 corresponds to the receiving data credit. The credit stored in the CREDIT Received 709 corresponds to the receiving buffer credit.

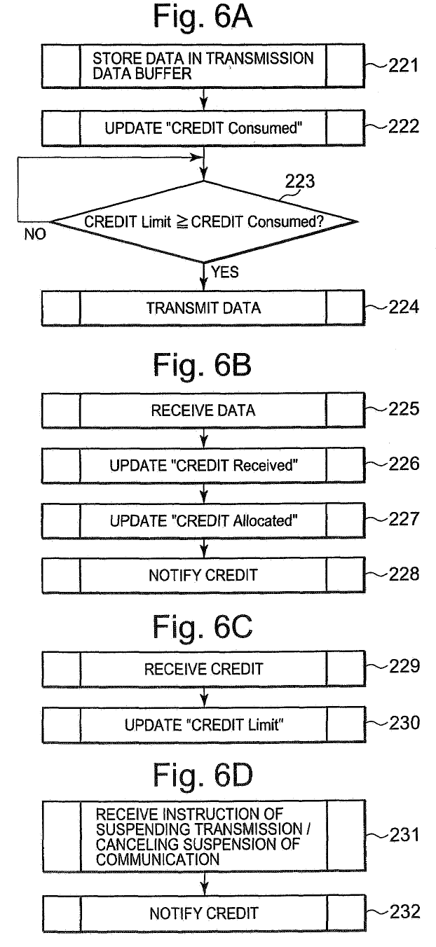

Subsequently, an operation of the flow control system shown in FIG. 5 is explained referring to FIGS. 6A to 6D. FIG. 6A illustrates an operation of the data transmission and updating the credit stored in the CREDIT Consumed 704 performed in the transmitting apparatus 701. FIG. 6B illustrates an operation of receiving the transmission data, updating the credit stored in the CREDIT Received 709, and updating the credit stored in the CREDIT Allocated 708, which are performed in the receiving apparatus 702. FIG. 6C illustrates an operation of updating the credit stored in the CREDIT Limit 705 based on the credit notification signal 710 performed in the transmitting apparatus 701. FIG. 6D illustrates an operation performed by the receiving apparatus 702 in a case in which the receiving apparatus 702 receives the transmission suspension instruction signal 713 indicating the instruction of suspending transmission with the transmitting apparatus 701 or the instruction of canceling the suspension of transmission with the transmitting apparatus 702.

In a case in which the data is-not being transmitted and there is no credit unprocessed in the system, in PCI-Express, the credit stored in the CREDIT Allocated 708 corresponds to the credit stored in the CREDIT Limit 705 in general. In the following, the credit stored in the CREDIT Allocated 708 and the credit stored in the CREDIT Limit 705 are assumed to be “A”. Accordingly, the credit which is stored in the accumulator 723 is also “A”. Further, it is assumed that no transmission data has been transmitted to the transmission data buffer 703 and the credit stored in the CREDIT Consumed 704 and the credit stored in the CREDIT Received 709 are both “0”. Accordingly, the accumulator 721 and the accumulator 722 also stores the credit whose value is “0”.

First, a process performed in a case in which the transmitting apparatus 701 has received the transmission data of the credit “C” from the internal circuit of the transmitting apparatus, will be explained.

As shown in FIG. 6A, the transmission data of the credit “C” is stored in the transmission data buffer 703 (Step 221). The credit “C” is accumulated by the accumulator 721 and the credit stored in the CREDIT Consumed 704 is updated (Step 222). In this case, since the accumulator 721 has the initial value of “0”, the credit stored in the CREDIT Consumed 704 is updated to “C”. The flow control circuit 706 compares the credit “A” stored in the CREDIT Limit 705 with the credit “C” stored in the CREDIT Consumed 704 (Step 223). In a case in which “C” is equal to or smaller than “A” as a result of the comparison, the data of the credit “A” is transmitted to the receiving apparatus 702 based on the flow control performed by the flow control circuit 706 (Step 224). Meanwhile, in a case in which “C” is larger than “A”, the flow control is performed so as to wait in Step 223 without transmitting the transmission data until “C” becomes equal to or smaller than the credit stored in the CREDIT Limit 705.

The transmitting apparatus 701 transmits data of the credit “C” as described above. Then, as shown in FIG. 6B, the receiving apparatus 702 receives data of the credit “C” (Step 225). The credit “C” is accumulated by the accumulator 722 to thereby update the credit stored in the CREDIT Received 709 (Step 722). In this case, since the accumulator 722 has the initial value of “0”, the credit stored in the CREDIT Received 709 is updated to “C”. Then, data of the credit “C” is transferred from the receiving data buffer 707 to the internal circuit of the receiving apparatus 702. The credit “C” is accumulated by the accumulator 723 and the credit stored in the CREDIT Allocated 708 is updated to “(A+C)” (Step 227). The credit selector 712 selects the credit stored in the CREDIT Allocated 708, and the credit “(A+C)” stored in the CREDIT Allocated 708 as the reception credit is notified to the transmitting apparatus 701 by using the credit notification signal 710 (Step 228).

When the receiving apparatus 702 transmits the credit notification signal 710, the transmitting apparatus 701 receives the credit “(A+C)” from the receiving apparatus 702 (Step 229 of FIG. 6C) The credit of the CREDIT Limit 705 is updated to “(A+C)” (Step 230). Then, the flowchart returns to Step 221 to repeat the above-mentioned process in order to transmit the subsequent transmission data.

Herein, it is assumed that the receiving apparatus 702 has received the instruction of suspending transmission with the transmitting apparatus 701 (Step 231 of FIG. 6D). The instruction is notified by the transmission suspension instruction signal 713. Then, the credit selector 712 selects the credit stored in the CREDIT Received 709 when the transmission suspension instruction signal 713 instructs the credit selector 712 to suspend transmission with the transmitting apparatus 701. The credit “C” stored in the CREDIT Received 709 as the reception credit is notified to the transmitting apparatus 701 by using the credit notification signal 710. The transmitting apparatus 701 receives the credit “C” from the receiving apparatus 702 (Step 229 FIG. 6C). Then, the credit stored in the CREDIT Limit 705 is updated to “C” (Step 230). It is assumed that the transmitting apparatus 701 has received the transmission data of the credit “D” in a case in which the credit stored in the CREDIT Limit 705 is “C”. In this case,, the data of the credit “D” is stored in the transmission data buffer 703 (Step 221 of FIG. 6A). Further, the credit stored in the CREDIT Consumed 704 is updated to “(C+D)” based on the accumulation performed by the accumulator 721 (Step 222). The flow control circuit 706 compares the credit “C” stored in the CREDIT Limit 705 with the credit “(C+D)” stored in the CREDIT Consumed 704 (Step 223). Since “(C+D)” is larger than “C”, the flow control is performed by the flow control circuit 706 so as to wait in Step 223 without transmitting the transmission data until “(C+D)” becomes equal to or smaller than the credit stored in the CREDIT Limit 705.

As described above, based on the transmission suspension instruction signal 713 giving the instruction of suspending transmission with the transmitting apparatus 701 , the data transmission between the transmitting apparatus 701 and the receiving apparatus 702 is suspended. The process of suspending the data transmission is explained as follows.

In the above-mentioned process, the credit stored in the CREDIT Received 709 is the sum of the credit of the data received by the receiving data buffer 707, that is, the sum of the credit of the transmission data which is supposed to be transmitted from the transmission data buffer 703. Therefore, the credit stored in the CREDIT Received 709 is equal to or smaller than the sum of the credit (that is, the credit stored in the CREDIT Consumed 704) of the transmission data stored in the transmission data buffer 703. Accordingly, by compulsorily making the credit stored in the CREDIT Limit 705 coincide with the credit stored in the CREDIT Received 709, the data transmission is prevented.

Subsequently, explanation will be made on a process for canceling the suspension of transmission.

The receiving apparatus 702 receives the instruction of canceling the suspension of transmission with the transmitting apparatus 701 (Step 231 of FIG. 6D). The instruction is notified by the transmission suspension instruction signal 713. As a result, the credit selector 712 selects the credit “(A+C)” stored in the CREDIT Allocated 708 (Step 232). The credit notification signal 710 notifies the selected credit “(A+C)” to the transmitting apparatus 701. As described above, the credit notification signal 710 is transmitted. Then, the transmitting apparatus 701 receives the credit “(A+C)” from the receiving apparatus 702 (Step 229 of FIG. 6C). As a result, the credit stored in the CREDIT Limit 705 is updated to “(A+C)” (Step 230). The credit “(A+C)” is larger than the credit “C” of the transmission data. Therefore, it is possible to advance from Step 223 to Step 224 in FIG. 6A whereby the data transmission is restarted from the transmission data buffer 703 to the receiving apparatus 702. In other words, by using the credit stored in the CREDIT Allocated 708, which is a proper credit to be notified to the transmitting apparatus 701, the operation of the flow control system performed in the normal conditions is restarted whereby the data transmission is restarted.

If a credit larger than the credit stored in the CREDIT Received 709 by a predetermined value is notified to the transmitting apparatus 701 instead of notifying the credit stored in the CREDIT Received 709, the flow control system according to the second embodiment may be configured such that only the transmission data having a credit, which is equal to or smaller than the credit larger than the credit stored in the CREDIT Received 709 by the predetermined value, is transmitted from the transmitting apparatus 701 irrespective of the currently available space of the receiving data buffer 707.

In a case in which the flow control system according to this embodiment is applied to the conventional system using PCI-Express, the conventional transmitting apparatus can be used as it is. Based on PCI-Express standard, the receiving apparatus 702 generally includes not only the CREDIT Allocated 708 being a register but also the CREDIT Received 709 being a register. Therefore, only by adding to the conventional receiving apparatus the credit selector 712 capable of being switched in response to the transmission suspension instruction signal 713, it is possible to apply the conventional receiving apparatus to the flow control of the present invention.

According to the present invention, in a case of suspending or controlling the data transmission from the transmitting apparatus 301, 701 in the receiving apparatus 302, 702, the receiving apparatus 302, 702 notifies the credit capable of reducing the value of the transmittable credit (in a case of PCI-Express, CREDIT Limit) to the transmitting apparatus 301, 701. As a result, according to the flow control process under the normal conditions based on the credit of the transmitting apparatus 301, 701, the data transmission from the transmitting apparatus 301, 701 to the receiving apparatus 302, 702 is prevented or limited. Therefore, the present invention produces an effect of suspending the data transmission from the transmitting apparatus 301, 701 at any time according to the instruction from the receiving apparatus 302, 702, irrespective of the available space of the receiving data buffer 307, 707, while eliminating a need to additionally provide a signal line for notifying the suspension of transmission.

Further, the flow control system of the present invention is different from the one in which the data transmission is suspended by not sending a reply which is supposed to be sent. Therefore, according to the present invention, a problem of reply time-out does not arise, and as a result, the reliable data transmission and flow control can be performed.

Further, in consideration of applying the flow control system of the present invention to the conventional system including the transmitting apparatus and the receiving apparatus of the conventional system, the flow control system of the present invention can be realized only by modifying the receiving apparatus. Therefore, according to the present invention, it is possible to save work and cost for implementation.

What is claimed is:

1. A system, comprising:
a first apparatus; and
a second apparatus which transmits first data of a first amount to said first apparatus,
wherein said first apparatus comprises:
a memory element which stores said first data;
a first controller which transmits a first signal for adjusting said first amount when said first amount need to be adjusted or a second signal corresponding to a second amount of a second data extracted from said memory element when said first amount does not need to be adjusted, to said second apparatus through a signal line; and
wherein said second apparatus comprises:
a second controller which updates a third signal corresponding to a third amount of third data that said first apparatus permits of receiving, based on said first signal; and
a third controller which determines to transmit said first data when said third amount is equal to or larger than said first amount.

2. The system according to claim 1, wherein said first controller requests said second controller to return said third amount to its state before update.

3. The system according to claim 1, wherein said first controller transmits said second signal to said second apparatus thorough said signal line, each time when said second data is extracted from said memory element.

4. The system according to claim 3, wherein said second apparatus comprises:
a circuit which performs calculation to obtain a fourth signal corresponding to said first amount of said first data to be transmitted to said first apparatus;
wherein said second controller which updates said third signal based on said first signal or said second signal, each time when said second controller receives said first signal or said second signal; and
wherein said third controller determines whether it is possible to transmit said first data to said first apparatus, by comparing said third signal and said fourth signal.

5. The system according to claim 1, wherein said first controller comprises:
a storage element which stores adjustment signal indicating whether or not to adjust said first amount;
wherein said first controller adds said adjustment signal to said first signal; and
wherein said first controller transmits said first signal including said adjustment signal to said second apparatus through said signal line.

6. The system according to claim 5, wherein said adjustment signal is used as a sign to indicate whether said first signal has a positive value or a negative value.

7. The system according to claim 6, wherein said adjustment signal added to said first signal comprises a negative sign when said adjustment signal indicates that it is necessary to adjust said first amount.

8. The system according to claim 4, wherein said first controller comprises:
a first storage element which stores adjustment signal indicating whether or not to adjust said first amount;
a select circuit which selects one's signal from said first signal and said second signal;
wherein said select circuit selects said first signal when said adjustment signal indicates that an adjustment for said first amount is necessary;
a second storage element which stores said first signal or said second signal selected by said select circuit;
wherein said first controller adds said adjustment signal to said first signal or said second signal; and
wherein said first controller transmits said first signal or said second signal including said adjustment signal to said second apparatus through said signal line.

9. The system according to claim 1, wherein said first signal indicates an available space of said memory element.

10. The system according to claim 9, wherein said second controller comprises:
a storage element which stores said third signal; and
a calculator which subtracts said available space indicated by said first signal from said third amount indicated by said third signal when said second controller receives said first signal.

11. An apparatus which receives first data of a first amount from another apparatus, comprising:
a memory element which stores said first data; and
a controller which transmits a first signal for adjusting said first amount when said amount need to be adjusted or a second signal corresponding to a second amount of a second data extracted from said memory element when said first amount does not need to be adjusted, to said another apparatus through a signal line.

12. The apparatus according to claim 11, wherein said controller comprises:
a storage element which stores adjustment signal indicating whether or not to adjust said first amount;
wherein said controller adds said adjustment signal to said first signal; and
wherein said controller transmits said first signal including said adjustment signal to said another apparatus through said signal line.

13. The apparatus according to claim 11, wherein said controller transmits said second signal to said another apparatus through said signal line, each time when said second data is extracted from said memory element.

14. The apparatus according to claim 13, wherein said controller comprises:
a first storage element which stores adjustment signal indicating whether or not to adjust said first amount;
a select circuit which selects one's signal from said first signal and said second signal;
wherein said select circuit selects said first signal when said adjustment signal indicates that an adjustment for said first amount is necessary;
a second storage element which stores said first signal or said second signal selected by said select circuit;
wherein said controller adds said adjustment signal to said first signal or said second signal; and
wherein said controller transmits said first signal or said second signal including said adjustment signal to said another apparatus through said signal line.

15. An apparatus which transmits first data of a first amount to another apparatus having a memory element for storing said first data, comprising:
a first controller which receives a first signal for adjusting said first amount when said another apparatus need to adjust said first amount or a second signal corresponding to a second amount of second data extracted from said memory element when said first amount does not need to be adjusted, from said another apparatus through a signal line;
wherein said first controller updates a third signal corresponding to a third amount of third data that said another apparatus permits of receiving, based on said first signal; and
a second controller which determines to transmit said first data when said third amount is equal to or larger than said first amount.

16. The apparatus according to claim 15, wherein said first signal indicates an available space of said memory element; and
wherein said controller subtracts said available space indicated by said first signal from said third amount indicated by said third signal when said controller receives said first signal.

17. A system, comprising:
a first apparatus; and
a second apparatus which transmits first data to said first apparatus,
wherein said first apparatus comprises:
a memory element which stores said first data;
a first storage element which stores a first signal corresponding to a first amount of second data extracted from said memory element;
a second storage element which stores a second signal corresponding to a second amount that is smaller than that of said first signal;
a select circuit which transmits said first signal to said second apparatus while said first apparatus accepts a data transmission from said second apparatus, and transmits said second signal to said second apparatus when said first apparatus suspends said data transmission from said second apparatus; and
said second apparatus comprises:
a third storage element which stores said first signal or said second signal as a third signal;
a fourth storage element which stores a fourth signal corresponding to a third amount of third data that is ready to be transmitted to said first apparatus; and
a controller which permits said data transmission when said third amount indicated by said fourth signal is equal to or smaller than that of said third signal.

18. The system according to claim 17, wherein said first apparatus and said second apparatus transmit and receive said first data based on PCI-Express protocol.

19. The system according to claim 17, wherein said second amount indicates an amount of said first data put into said memory element.

20. A method for controlling a system having a first apparatus and a second apparatus transmitting first data of a first amount to said first apparatus, comprising:
storing said first data in a memory element;
transmitting a first signal for adjusting said first amount when said first amount need to be adjusted or a second signal corresponding to a second amount of a second data extracted from said memory element when said first amount does not need to be adjusted, to said second apparatus through a signal line; and
updating a third signal corresponding to a third amount of said third data that said first apparatus permits of receiving, based on said first signal; and
determining to transmit said first data when said third amount is equal to or larger than said first amount.

21. The method according to claim 20, further comprises:
transmitting said second signal to said second apparatus through, each time when said second data is extracted from said memory element.

22. The method according to claim 21, further comprises:
performing calculation to obtain a fourth signal corresponding to said first amount of said first data to be transmitted to said first apparatus;
updating said third signal based on said first signal or said second signal; and
determining whether it is possible to transmit said first data to said first apparatus, by comparing said third signal and said fourth signal.

23. The method according to claim 20, further comprises:
storing adjustment signal indicating whether or not to adjust said first amount;
adding said adjustment signal to said first'signal; and
transmitting said first signal including said adjustment signal to said second apparatus through said signal line.

24. The method according to claim 22, further comprises:
storing adjustment signal indicating whether or not to adjust said first amount;
selecting one's signal from said first signal and said second signal;
selecting said first signal when said adjustment signal indicates that an adjustment for said first amount is necessary;
storing said first signal or said second signal in a second storage element;
adding said adjustment signal to said first signal or said second signal; and
transmitting said first signal or said second signal including said adjustment signal to said second apparatus.

25. The method according to claim 20, wherein said first signal indicates an available space of said memory element.

26. The method according to claim 25, further comprises:
storing said third signal in a storage element; and
subtracting said available space indicated by said first signal from said third amount indicated by said third signal.

27. A method of controlling a apparatus, comprising:
receiving first data of a first amount from another apparatus;
storing said first data in a memory element; and
transmitting a first signal for adjusting said first amount when said amount of said data need to be adjusted or a second signal corresponding to a second amount of a second data extracted from said memory element when said first amount does not need to be adjusted, to said another apparatus through a signal line.

28. The method according to claim 27, further comprising:
storing adjustment signal indicating whether or not to adjust said first amount in a storage element;
adding said adjustment signal stored in said storage element to said first signal;
transmitting said first signal including said adjustment signal to said another apparatus through said signal line.

29. The method according to claim 28, further comprising:
transmitting said second signal to said another apparatus through said signal line, each time when said second data is extracted from said memory element.

30. The method according to claim 29, further comprises:
storing adjustment signal indicating whether or not to adjust said first amount in a first storage element;
selecting one's signal from said first signal and said second signal;
selecting said first signal when said adjustment signal indicates that an adjustment for said first amount is necessary;
storing said first signal or said second signal in a second storage element;
adding said adjustment signal stored in said first storage element to said first signal or said second signal; and
transmitting said first signal or said second signal including said adjustment signal to said another apparatus through said signal line.

31. A method for controlling an apparatus which transmits first data of a first amount to another apparatus having a memory element for storing said first data, comprising:
receiving a first signal for adjusting said first amount when said another apparatus need to adjust said first amount or a second signal corresponding to a second amount of second data extracted from said memory element when said first amount does not need to be adjusted, from said another apparatus through a signal line;
updating a third signal corresponding to a third amount of said third data that said another apparatus permits of receiving, based on said first signal; and
determining to transmit said first data when said third amount is equal to or larger than said first amount.

32. The method according to claim 31, further comprises:
wherein said first signal indicates an available space of said memory element;
subtracting said available space indicated by said first signal from said third amount indicated by said third signal.
